(19) United States
(12) Patent Application Publication
(10) Pub. No.: US 2015/0338039 A1
(43) Pub. Date: Nov. 26, 2015

(54) SAFETY ELECTRICAL SOCKET FACEPLATE

(71) Applicant: Shaun Whitney Magee, Langley (CA)

(72) Inventor: Shaun Whitney Magee, Langley (CA)

(21) Appl. No.: 14/338,714

(22) Filed: Jul. 23, 2014

(30) Foreign Application Priority Data
May 21, 2014 (CA) 2851989

(51) Int. Cl. F21S 8/00; F21V 23/04

(52) U.S. Cl. CPC F21S 8/035; F21V 23/0464

(57) ABSTRACT

A safety electrical socket box faceplate includes a planar body member. The planar body has first, second, third and fourth side members each extending substantially equally and in the same general direction away from the planar body member. The first member is horizontally disposed on an opposite side of the body member from the second member, and the third member is vertically disposed on an opposite side of the body member from the fourth member. First and second directional illuminatable indicators are located on an exterior face of the body member, and an energizing circuit configured to draw electricity from the socket box is in electrical communication with the directional indicators to energize the directional indicators.

### FIELD OF THE INVENTION

The invention relates to the electrical field in particular to a safety electrical socket faceplate which can be attached to a conventional electrical socket box.

### BACKGROUND OF THE INVENTION

Every year, hundreds of lives are lost during building fires. Many who have lived through building fires were able to escape by finding readily viewable exit signs located atop walls or attached to ceilings. Although somewhat effective, these exit signs are often clouded over when the amount of smoke in a building reaches a certain level, consequently rendering them useless in smoky conditions. As part of fire safety education, the public is instructed to keep low to the ground when faced with a fire situation. This further exacerbates one's ability to readily find existing exit signs in smoky conditions.

Accordingly, it would be highly desirable to provide an exit safety device that is readily viewable in smoky conditions and one that is located next to ground level. Other aspects of the invention will be appreciated by reference to the detailed description of the preferred embodiment and to the claims that follow.

### SUMMARY OF THE INVENTION

According to the present invention there is provided a safety electrical socket box faceplate. The faceplate includes a planar body member having first, second, third and fourth side members each extending substantially equally and in the same general direction away from the planar body member. The first member may be horizontally disposed on an opposite side of the body member from the second member, and the third member may be vertically disposed on an opposite side of the body member from the fourth member.

The faceplate also includes a first directional illuminatable indicator on a face of the body member and near to the first member. Additionally, a second directional illuminatable indicator on the face of the body member is provided near to the second member. The first and second directional illuminatable indicators may each respectively wrap from the face of the body member around to and along the first and second side members.

Additionally, there may be an energizing circuit configured to draw electricity from the socket box and in electrical communication with the directional indicators to energize the directional indicators.

The faceplate may also include a light sensor on the body member, preferably on the third member of the body member. A computer processing unit (CPU) may be included that is in electrical communication with the light sensor, the directional illuminatable indicators, and the energizing circuit. The CPU may be operable in order to determine whether the light sensor is sensing light. The CPU may further be operable allow the energizing circuit to energize the directional illuminatable indicators when the light sensor is not sensing light and operable to prevent the energizing circuit from energizing the directional illuminatable indicators when the light sensor is sensing light.

A battery backup may further be included that is in electrical communication with the light sensor, the CPU, and the directional illuminatable indicators. The battery backup may be operable to energize the directional illuminatable indicators when the CPU determines that the energizing circuit is unable to draw electricity from the socket box and when the CPU determines that the light sensor is not sensing light.

The energizing circuit may include two electrical prongs configured for insertion into a socket of the electrical socket box.

The directional illuminatable indicators may each be a reflector. Here, the first reflector may be first colour, such as green, and the second reflector may be a second colour, for example, red.

Alternatively, the directional illuminatable indicators may each be a light source, for example, a light emitting diode. Here, the first light source may be a first colour, such as green, and said second light source may be a second colour, for example, red.

In the alternative, the directional illuminatable indicators may each be a light source, and a lens. Here, the first lens may be a first coloured lens, such as green, and said second lens may be a second coloured lens, for example, red.

Finally, the faceplate may further include a removable access panel to allow a user to utilize a socket of the socket box and an illuminatable window on the face of the body member that wraps around the face to along the fourth member. The illuminatable window may also be energized by the energizing circuit.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a front perspective view of a safety electrical socket faceplate of the present invention;

FIG. 2 is a side view of FIG. 1;

FIG. 3 is a top view of FIG. 1;

FIG. 4 is a front plan view of FIG. 1;

FIG. 5 is a bottom view of FIG. 1;

FIG. 6 is a rear perspective view of FIG. 1; and

FIG. 7 is a rear plan view of FIG. 1.

### DESCRIPTION OF THE PREFERRED EMBODIMENT OF THE INVENTION

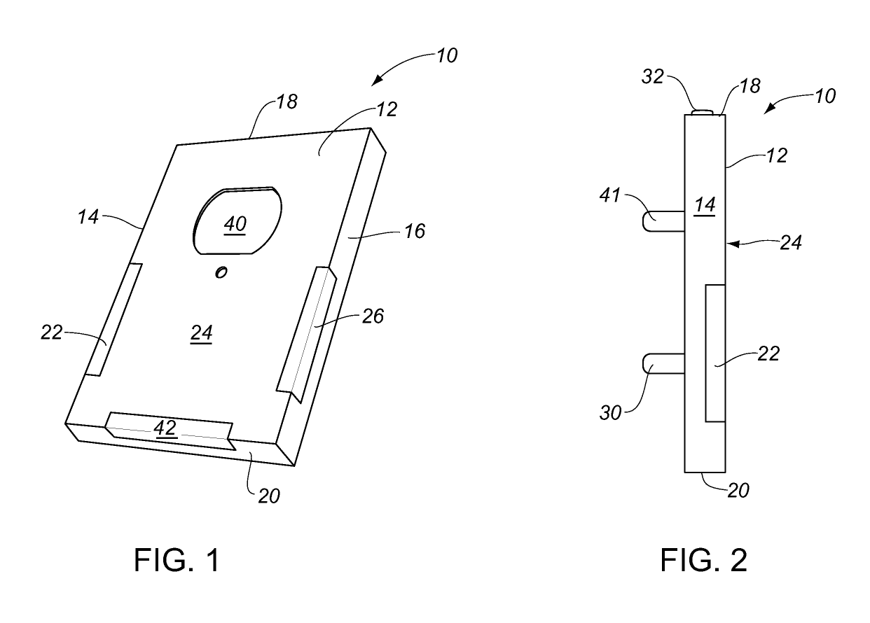

Referring to FIGS. 1, 4 and 6, there is depicted a safety electrical socket box faceplate 10. For convenience and ease of installation and use, faceplate 10 is shaped to resemble a conventional socket faceplate. As such, faceplate 10 includes a planar body member 12 having first 14, second 16, third 18 and fourth 20 side members each extending substantially equally and in the same direction away from the planar body member. First member 14 is horizontally disposed on an opposite side of body member 12 from second member 16, and third member 18 is vertically disposed on an opposite side of body member from fourth member 20. To accommodate features of the invention, the dimensions of faceplate 10 may be somewhat larger than conventional faceplates, but as those skilled in the art will appreciate, specific dimensions of the faceplate 10 and its components are not essential to its operation. Faceplate 10 may be constructed of conventional means and materials. For example, faceplate 10 may be constructed via a plastic mold or from a metal, such as aluminum, bent and cut into shape.

Faceplate 10 includes a first directional illuminatable indicator 22 on a face 24 of body member 12 near to first member 14. A second directional illuminatable indicator 26 is also provided on face 24 of body member 12 near to second member 16. In the preferred embodiment, first 22 and second 26 directional illuminatable indicators each respectively wrap from face 24 of body member 12 around to and along first 14 and second 16 side members, as depicted in FIG. 2. This is advantageous for users as a user is able to view the directional illuminatable indicators from the sides of faceplate 10, rather than having to rely upon viewing the directional illuminatable indicators from only the front of faceplate 10. In emergency situations, every split second a user saves in finding an emergency exit is critical to survival.

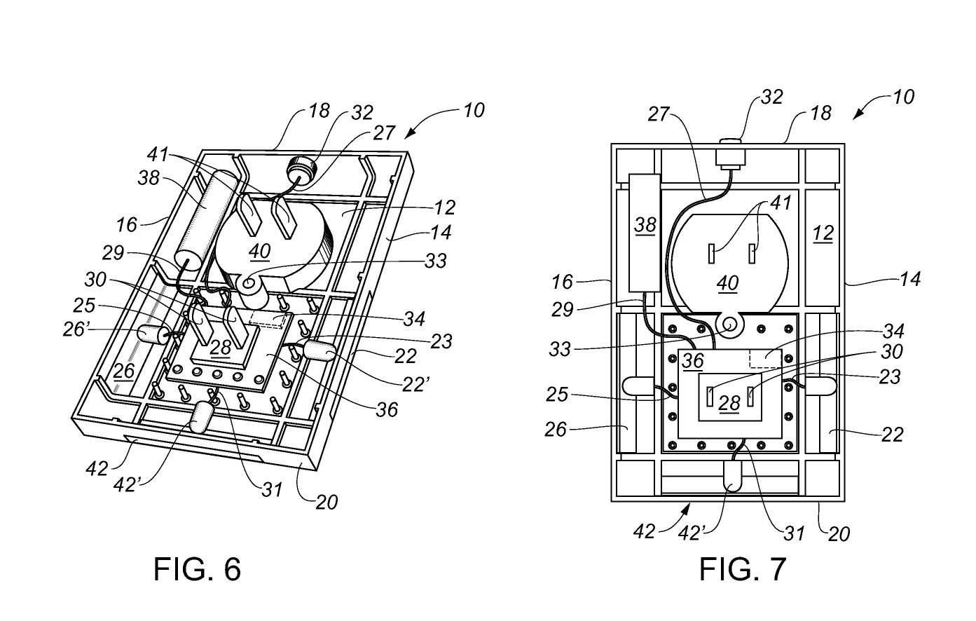

Referring to FIGS. 6 and 7, an energizing circuit such as the energizing means 28 is provided and is configured to draw electricity from a socket box [not depicted] and is in electrical communication with the first 22 and second 26 directional illuminatable indicators via the wires 23 and 25, respectively. Preferably, energizing means 28 include two electrical prongs 30 configured for insertion into a socket of the electrical socket box. In this configuration, a user can simply remove an existing wall socket faceplate and replace it with faceplate 10 as the electrical prongs 30 simply connect into the existing socket. Preferably, body member 12 and prongs 30 are dimensioned so that faceplate 10 sits flush to the wall during installation via a screw [not depicted] which fits through hole 33 on body member 12 into existing screw holes found in the electrical socket box. As those skilled in the art will appreciate, energizing means 28 also includes hardwiring faceplate 10 to the electrical wires in the socket box as well as other devices used to connect the wires of the socket box to faceplate 10.

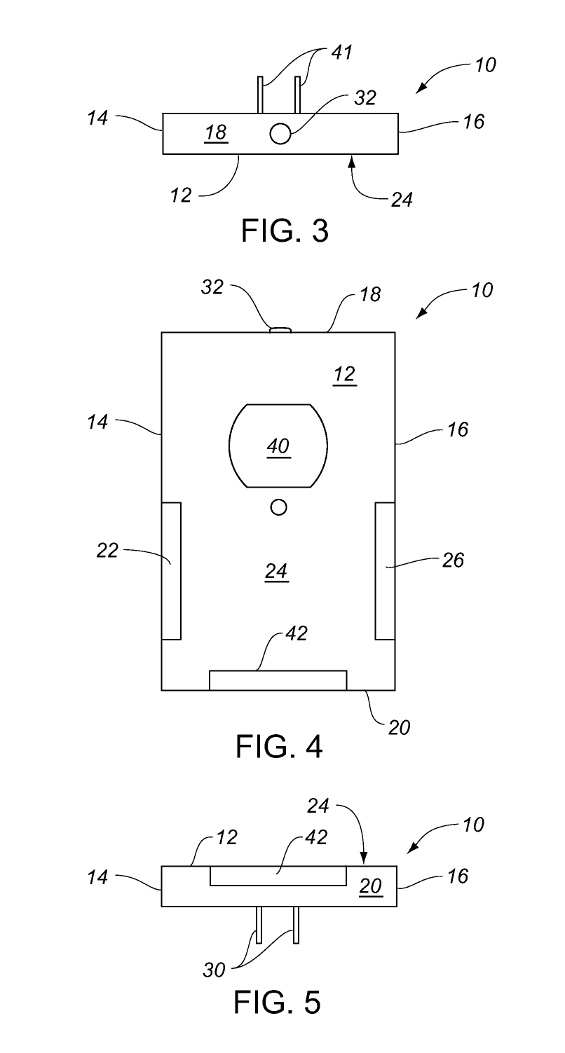

With faceplate 10 connected to electricity, first 22 and second 26 directional illuminatable indicators are always powered by the electrical socket box should the electrical socket box be operational. To save electricity and only power the directional illuminatable indicators during periods of relative darkness, in the preferred embodiment, faceplate 10 also includes a light sensor 32 and a computer processing unit (CPU) 34 Light sensor 32 is connected to body member 12, preferably on third member 18 of the body member, as depicted in FIG. 3. In the preferred embodiment, CPU 34 is attached to a motherboard 36. Motherboard 36 is preferably dimensioned to sit flush inside body member 12, but it is also envisioned that the motherboard could be an integral part of the body member. Energizing means 28, light sensor 32, and first 22 and second 26 directional illuminatable indicators are in electrical communication with CPU 34 via connection with motherboard 36 and wires 23, 25, and 27. CPU 34 is programmed to determine whether light sensor 32 is sensing light. When light sensor 32 is sensing light, CPU 34 is programmed to prevent energizing means 28 from energizing first 22 and second 26 directional illuminatable indicators. On the other hand, when light sensor 32 is not sensing light, CPU 34 is programmed to allow energizing means 28 to energize first 22 and second 26 directional illuminatable indicators.

As a further safety measure, faceplate 10 includes a battery backup 38 which is also in electrical communication with CPU 34, the directional illuminatable indicators, and light sensor 32 via motherboard 36 and wire 29. Battery backup 38 is operable to energize the directional illuminatable indicators when CPU 34 determines that energizing means 28 is unable to draw electricity from the socket box and when the CPU determines that light sensor 32 is not sensing light.

Referring to FIGS. 1, 4, 6 and 7 to allow a user to plug in an appliance, faceplate 10 may further include a removable access panel 40. Panel 40 may be removed from body member 12 prior to installation of faceplate 10 and is essentially a dummy plug with plastic prongs 41. When not removed, access panel 40 via plastic prongs 41 help to further secure plate 10 to the socket box.

Referring to FIGS. 1, 5, 6 and 7, an illuminatable window 42 on face 24 of body member 12 is also provided to provide general illumination. Window 42 preferably wraps around face 24 to along fourth member 20 and is also in electrical communication with energizing means 28 via motherboard 36 and wire 31. Preferably, window 42 includes a light source 42′.

First 22 and second 26 directional illuminatable indicators in one embodiment are each simply reflectors. Here, first 22 reflector may be a first colour, such as green, and second 26 reflector may be a second colour, for example, red. It will be appreciated, that first 22 and second 26 directional illuminatable indicators can be reversed with first 22 and second 26 indicators being on either side of body member 12 depending upon a user's preference. The use of colours enables quick and easy determination of the intended direction of travel and are internationally recognized forms of signaling.

Alternatively, the directional illuminatable indicators may each be a light source, for example, a light emitting diode. Here, the first 22 light source may be a first colour, such as green, and the second 26 light source may be a second colour, for example, red.

In the preferred embodiment, the directional illuminatable indicators are each a light source, and a lens. Here, first 22 lens may be a first coloured lens, such as green, and second 26 lens may be a second coloured lens, for example, red. Here, first 22′ light source and second 26′ light source may be clear light emitting diodes.

For all of the above embodiments, it is contemplated that first 22 and second 26 directional illuminatable indicators may be easily replaceable permitting ease of maintenance and customization. It is also contemplated that first 22 and second 26 directional illuminatable indicators are not limited to simply coloured indicators, but may also include other visual cues, such as symbols and words.

In operation, a user installs a number of faceplates 10 in a building. In a corridor, for example, a user would install several faceplates 10 along the walls. Once determining the correct safety pathway, a user would match the directional illuminatable indicators on each faceplate 10 in accordance with the correct pathway. For example, if the correct pathway, when facing faceplate 10 is to the right, a user would configure the preferred faceplate 10 so that the right-hand side indicator showed green and the left-hand side indicator showed red. In this manner, in an emergency smoky situation, a user close to the ground would be able to quickly view faceplate 10 and make an easy determination as to which direction he or she would travel to safety, green being to conventional colour to go and red being the conventional colour to stop. As a user looks down a corridor, he would be faced with either green or red indicators, making it easy for the user to determine the correct safety pathway.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. A safety electrical socket box faceplate comprising:
a planar body member, said planar body member having first, second, third and fourth side members each extending substantially equally and in the same general direction away from said planar body member, said first member being horizontally disposed on an opposite side of said body member from said second member, and said third member being vertically disposed on an opposite side of said body member from said fourth member;
a first directional illuminatable indicator on an exterior face of said body member near to said first member;
a second directional illuminatable indicator on said face of said body member near to said second member; and
an energizing circuit configured to draw electricity from the socket box and in electrical communication with said directional indicators to energize said directional indicators.

2. The faceplate of claim 1 wherein said first and second directional illuminatable indicators each respectively wrap from said face of said body member around to and along said first and second side members.

3. The faceplate of claim 1 further comprising a light sensor on said body member.

4. The faceplate of claim 3 wherein said light sensor is on said third member of said body member.

5. The faceplate of claim 3 further comprising a computer processing unit (CPU) in electrical communication with said energizing circuit, said light sensor, and said first and second directional illuminatable indicators, said CPU operable to determine whether said light sensor is sensing light and operable to allow said energizing circuit to energize said directional illuminatable indicators when said light sensor is not sensing light and operable to prevent said energizing circuit from energizing said directional illuminatable indicators when said light sensor is sensing light.

6. The faceplate of claim 5 further comprising a battery backup in electrical communication with said light sensor, said CPU and said directional illuminatable indicators, said battery backup operable to energize said directional illuminatable indicators when said CPU determines that said energizing circuit is unable to draw electricity from the socket box and when said CPU determines that said light sensor is not sensing light.

7. The face plate of claim 1 wherein said directional illuminatable indicators each comprise a reflector.

8. The faceplate of claim 7 wherein said first reflector comprises a first colour and said second reflector comprises a second colour.

9. The faceplate of claim 8 wherein said first colour is green and said second colour is red.

10. The face plate of claim 1 wherein said directional illuminatable indicators each comprise a light source.

11. The faceplate of claim 10 wherein said first light source comprises a first colour and said second light source comprises a second colour.

12. The faceplate of claim 11 wherein said first colour is green and said second colour is red.

13. The faceplate of claim 1 wherein said directional illuminatable indicators each comprise a light source and a lens.

14. The faceplate of claim 13 wherein said first lens comprises a first coloured lens and said second lens comprises a second coloured lens.

15. The faceplate of claim 14 wherein said first coloured lens is green and said second coloured lens is red.

16. The faceplate of claim 10 wherein said light source comprises a light emitting diode.

17. The faceplate of claim 13 wherein said light source comprises a light emitting diode.

18. The faceplate of claim 1 wherein said body member comprises a removable access panel to allow a user to utilize a socket of the socket box.

19. The faceplate of claim 1 further comprising an illuminatable window on said face of said body member near to said fourth member and wrapping around said face to along said fourth member, said illuminatable window in electrical communication with said energizing circuit.

20. The faceplate of claim 1 wherein said energizing circuit comprises two electrical prongs configured for insertion into a socket of the electrical socket box.
